(19) United States
(12) Patent Application Publication
(10) Pub. No.: US 2026/0153816 A1
(43) Pub. Date: Jun. 4, 2026

(54) FIXING DEVICE

(71) Applicant: CANON KABUSHIKI KAISHA, Tokyo (JP)

(72) Inventor: SHINJI KUBO, Kanagawa (JP)

(21) Appl. No.: 19/401,072

(22) Filed: Nov. 25, 2025

(30) Foreign Application Priority Data
Dec. 2, 2024 (JP) 2024-209699

(51) Int. Cl. G03G 15/20

(52) U.S. Cl. CPC G03G 15/2017; G03G 15/2064

(57) ABSTRACT

A fixing device includes a connector cap mounted to a power supply connector, the connector cap has a cutaway portion through which a power supply cable passes, and the power supply cable is insertable into the cutaway portion.

### BACKGROUND

### Field of the Technology

The present disclosure relates to a fixing device, installed in an image forming device that uses electrophotographic recording technology, that fixes a toner image formed on a recording material to the recording material.

### DESCRIPTION OF THE RELATED ART

Japanese Patent Laid-Open No. 11-345680 discusses a fixing device that includes a cylindrical belt (also referred to as a film) and a heater disposed in the internal space of the belt and a roller, in contact with the outer peripheral surface of the belt, that pinches the belt together with the heater to form a fixing nip portion between the roller and the belt. A power supply connector is connected to the heater to supply power to the heater.

### SUMMARY

The present disclosure provides a fixing device with improved ease of assembly of the connector cap attached to the power supply connector.

The present disclosure provides a fixing device that includes a fixing belt; a heater that includes a board, a resistor provided in a longitudinal direction on an end portion of the board, and an electrode; a holder disposed in an internal space of the fixing belt and configured to hold the heater in the longitudinal direction; a power supply connector configured to supply power to the heater, the power supply connector including a contact configured to conductively contact the electrode, a housing configured to accommodate the contact, and a power supply cable connected to the contact; and a connector cap configured to mount to the power supply connector. The connector cap has a cutaway portion configured for the power supply cable to pass therethrough. The power supply cable is configured to be insertable into the cutaway portion.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are cross-sectional and perspective views, respectively, of a fixing device.

FIG. 2 is a cross-sectional view of an image forming device.

FIG. 3 is a cross-sectional view of a heating unit and a pressure roller.

FIG. 4 is a cross-sectional view of the fixing device.

FIG. 5 is an exploded perspective view of the fixing device.

FIG. 6A is a cross-sectional view of a pressure mechanism in a pressurized state, and FIG. 6B is a cross-sectional view of the pressure mechanism in a pressure release state.

FIG. 7 is an exploded perspective view of a lower frame, an upper frame, a camshaft, and a cam.

FIG. 8 is a diagram illustrating the relationship between a heater, a connector, a power supply unit, and a thermostat.

FIGS. 9A to 9C are perspective views of a connector and a connector cap according to example 1.

FIGS. 10A to 10C are perspective views of the connector and the connector cap according to example 1.

FIGS. 11A and 11B are perspective views of the connector and the connector cap according to example 1.

FIGS. 12A and 12B are cross-sectional and perspective views, respectively, of a fixing device according to example 2.

FIGS. 13A to 13C are perspective views of a connector and a connector cap according to example 2.

FIGS. 14A to 14C are perspective views of the connector and the connector cap according to example 2.

FIGS. 15A to 15C are perspective views of the connector and the connector cap according to example 2.

FIGS. 16A and 16B are structure diagrams of a fixing device according to example 3.

FIGS. 17A to 17C are perspective views of a connector and a connector cap according to example 3.

FIGS. 18A to 18C are perspective views of the connector and the connector cap according to example 3.

FIGS. 19A to 19C are perspective views of the connector and the connector cap according to example 3.

### DESCRIPTION OF THE EMBODIMENTS

### Example 1

Examples of the present disclosure will be described in detail below with reference to the drawings.

### Image Forming Device

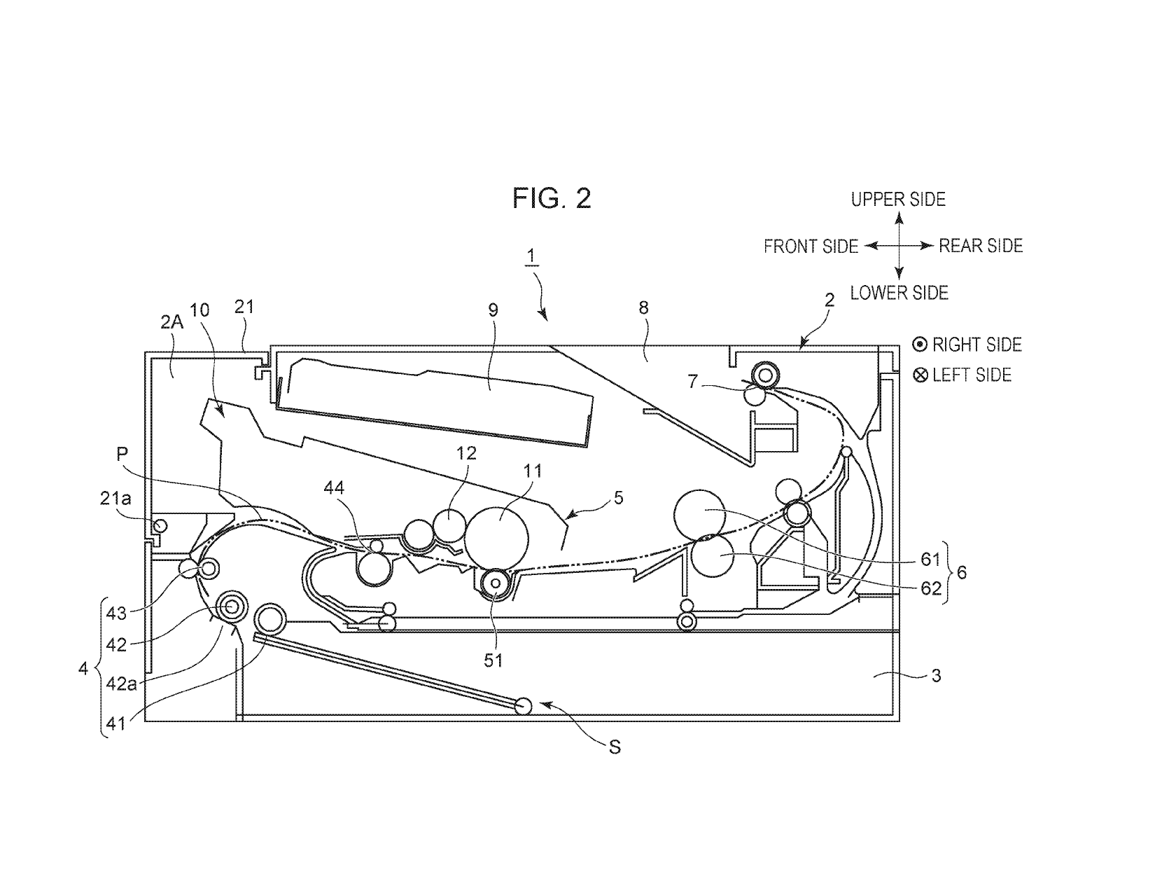

FIG. 2 is a cross-sectional view illustrating a schematic structure of a laser beam printer 1, which is an example of an image forming device that uses electrophotographic recording technology. The dimensions, materials, shapes, and relative dispositions of the components described in the following examples may be changed as appropriate according to the structure and various conditions of devices to which the present disclosure is applied. Accordingly, unless otherwise specifically described, the scope of the present disclosure is not limited to these examples.

In addition, the upper side and the lower side in FIG. 2 are defined as the upper side and the lower side of the laser beam printer 1, respectively.

As illustrated in FIG. 2, the laser beam printer 1 includes a device body 2 and a process cartridge 10, and the process cartridge 10 is detachably installed in the device body 2. The device body 2 includes a sheet feed tray 3, a sheet feed unit 4, a conveyance path P, an image forming unit 5, a fixing device 6, a sheet discharge unit 7, a sheet discharge tray 8, a laser scanner 9, and the like. On the other hand, the cartridge 10 includes an electro-photosensitive drum 11, a developing roller 12 as a developer carrier, and the like.

The device body 2 has an open-close door 21 that blocks an opening 2A through which the process cartridge 10 is attached and detached. The open-close door 21 is supported pivotably about a pivot shaft 21a and is movable between a closed position at which the opening 2A is closed and an open position at which the opening 2A is opened.

The sheet feed unit 4 includes a sheet feed roller 41, a separating roller 42, a separating pad 42a, and a conveyance roller pair 43. In accordance with a print start signal, a sheet (recording material) S stored in a sheet feed tray 3 is sent to a conveyance path P by the sheet feed unit 4 and is conveyed toward the image forming unit 5 through a registration roller pair 44.

When the sheet S is conveyed to a predetermined position, an image formation start signal is issued, and an image formation process is started. The electro-photosensitive drum 11 is rotationally driven by a driving source (motor), and is uniformly charged with a predetermined potential by a charger. The charged surface of the electro-photosensitive drum 11 is exposed to light in accordance with image information by the laser scanner 9, the electric charge of the exposed portion is removed, and an electrostatic image is formed. The toner in the process cartridge 10 is carried by the developing roller 12 and supplied to the electro-photosensitive drum 11 in accordance with an electrostatic latent image, and a latent image is developed.

As a result, the latent image is visualized as a toner image on the electro-photosensitive drum 11.

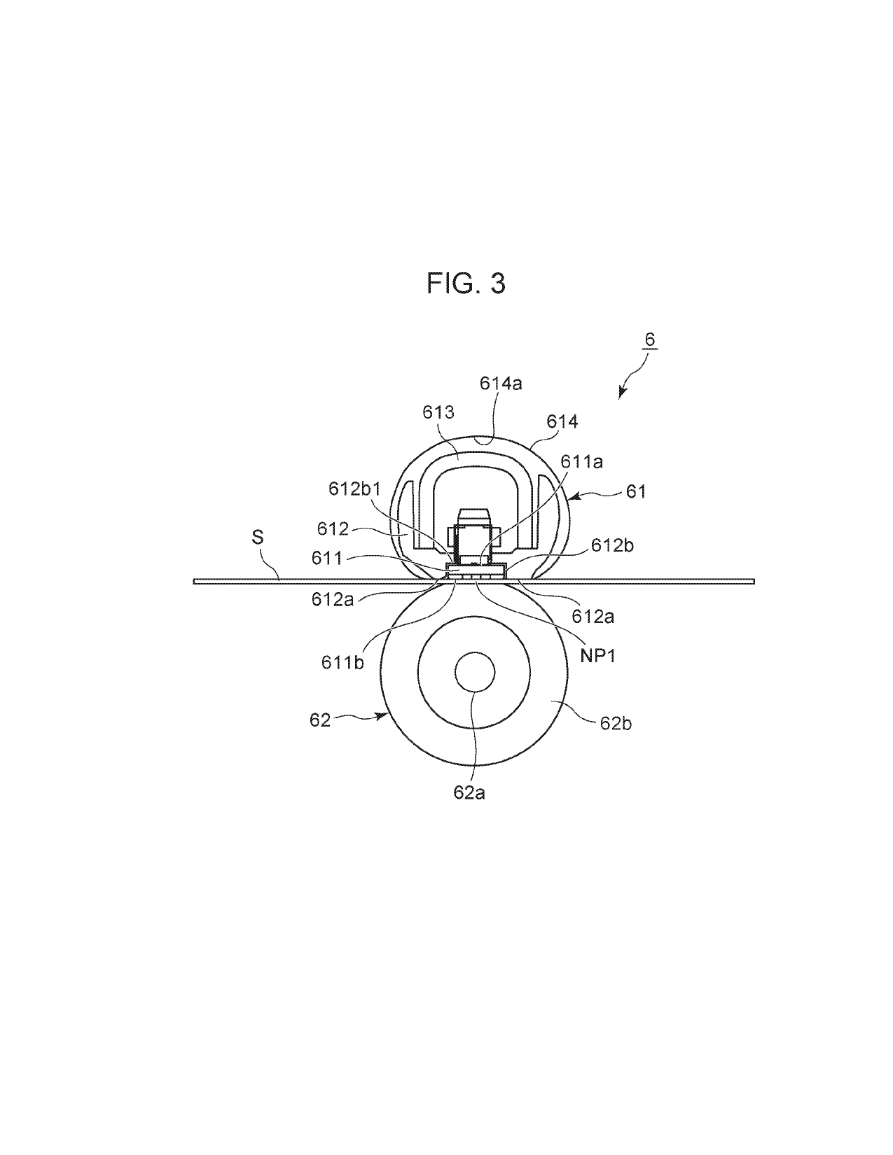

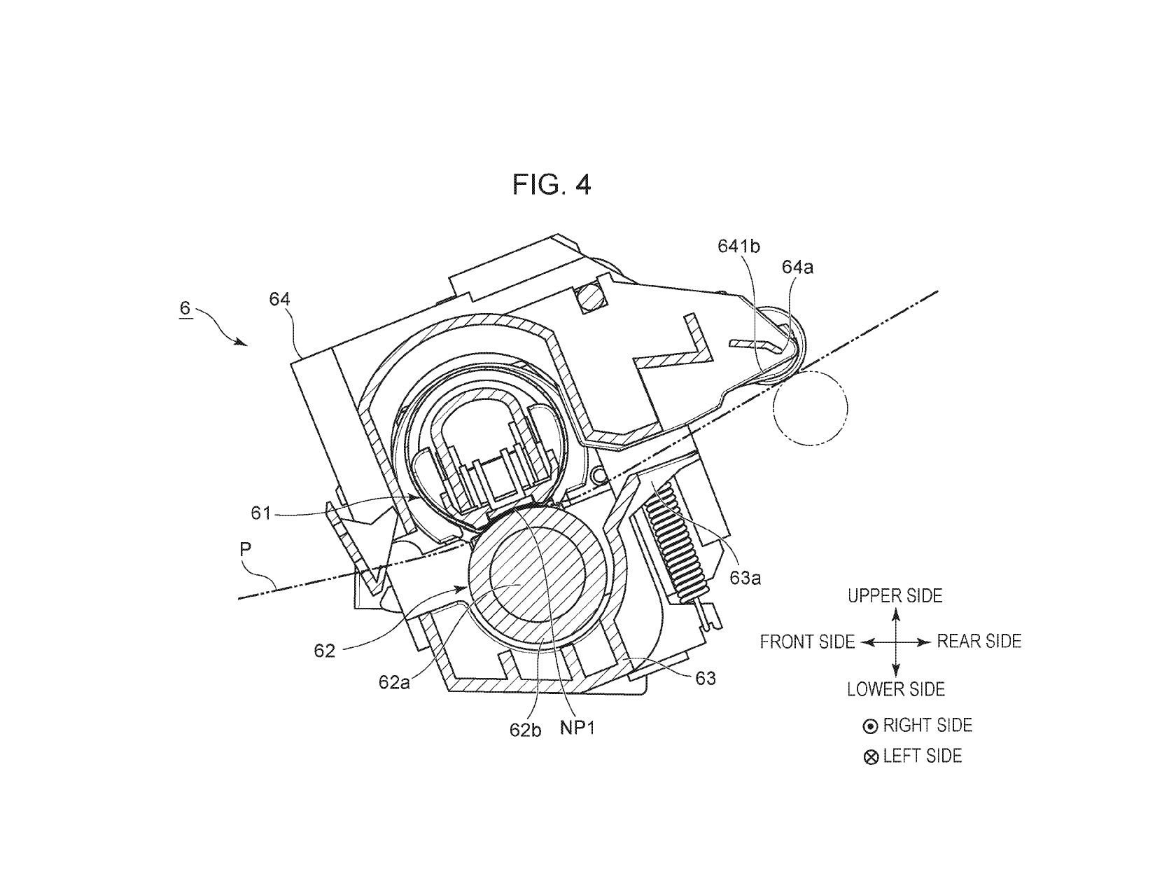

The image forming unit 5 includes the process cartridge 10 and a transfer roller 51 disposed so as to face the electro-photosensitive drum 11 of the process cartridge 10. When the sheet S conveyed by the registration roller pair 44 reaches the image forming unit 5 and passes through a fixing nip portion NP1 (FIGS. 3 and 4) between the electro-photosensitive drum 11 and the transfer roller 51, a voltage from the device body 2 is applied to the transfer roller 51, and the toner image on the electro-photosensitive drum 11 is transferred to the sheet S as an unfixed image. After that, the sheet S to which the toner image has been transferred is conveyed to the fixing device 6 including a heating unit 61 and a pressure roller 62. When the sheet S passes through the fixing nip portion NP1 between the heating unit 61 and the pressure roller 62, the unfixed image transferred to the sheet S is fixed to the surface of the sheet S by being heated and pressurized. The sheet S to which the toner image has been fixed is discharged to the sheet discharge tray 8 via the sheet discharge unit 7.

### Fixing Device

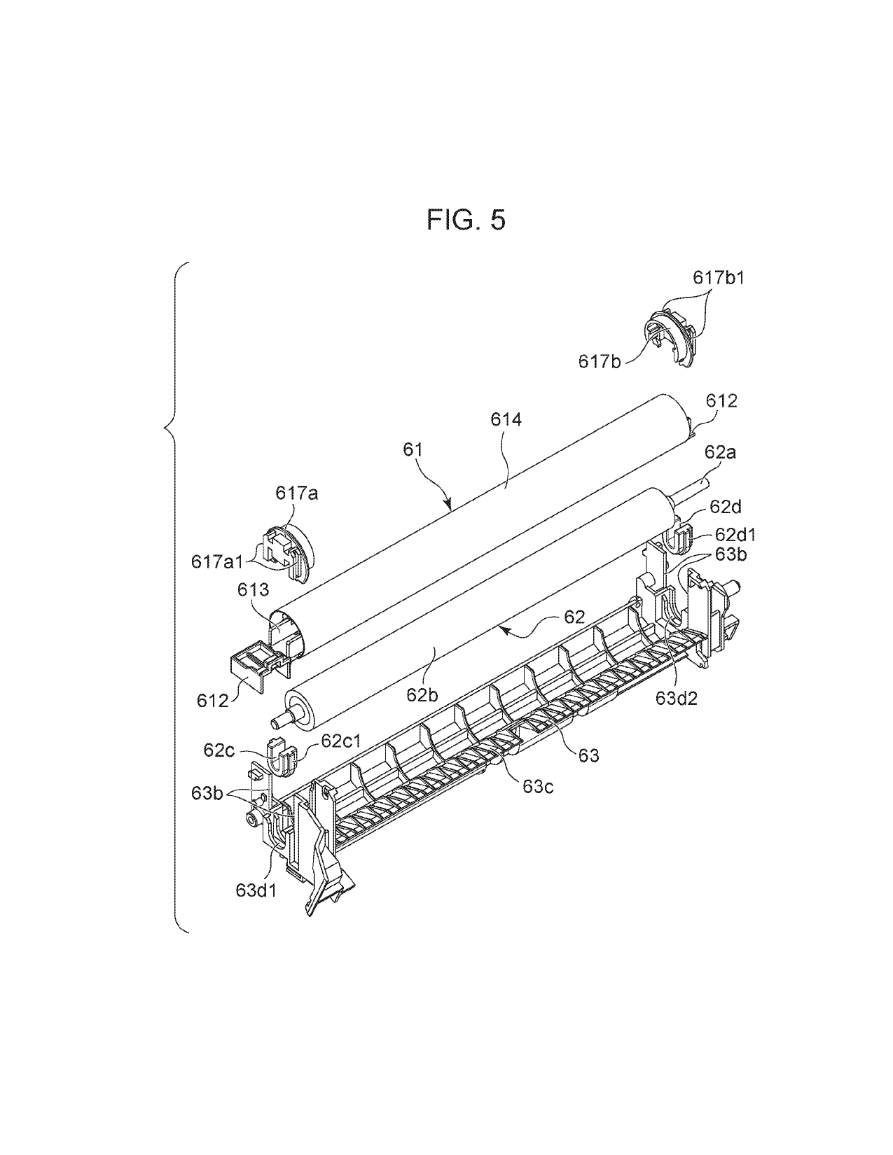

The specific structure of the fixing device will be described with reference to FIGS. 3 to 5. As illustrated in FIG. 3, the heating unit 61 of the fixing device 6 includes a heater 611, a holder (heater holder) 612, a stay 613, and a belt (cylindrical fixing belt) 614. The heater 611 is a flat plate extending in the left-right direction and includes a first surface 611a and a second surface 611b on the opposite side of the first surface 611a, and the first surface 611a is supported by the holder 612. The longitudinal direction of the heater 611 is the same as the left-right direction of the laser beam printer 1. The heater 611 is disposed in an internal space of the belt 614.

The holder 612 is formed of a heat-resistant resin, such as polyphenylene sulfide (PPS) or liquid crystal polymer, and includes a guide surface 612a and a supporting wall 612b. The guide surface 612a guides the belt 614 while being in contact with an inner peripheral surface 614a of the belt 614, and the supporting wall 612b has a supporting surface 612b1 that supports the heater 611. The supporting surface 612b1 of the supporting wall 612b abuts against the first surface 611a of the heater 611. The stay 613 is a member that supports the holder 612 and is formed by bending a plate material having a greater rigidity than the holder 612, such as a steel plate with a thickness of 1.6 mm, into a substantially U-shape.

The belt 614 is an endless belt (also referred to as a film) that has heat resistance and flexibility, and the belt 614 is, for example, a sleeve of a metal, such as stainless steel, that is coated with fluororesin, or a laminated member of polyimide resin, silicone rubber, or fluororesin. The heater 611, the holder 612, and the stay 613 are disposed inside the belt 614, and the belt 614 is configured to rotate around these components. The inner peripheral surface 614a of the belt 614 is in contact with the second surface 611b of the heater 611.

### Pressure Mechanism

As illustrated in FIGS. 3 to 5, the pressure roller 62 includes a metal shaft 62a and a rubber roller 62b made of an elastic body that covers the shaft 62a and is pressed against the heater 611 via the belt 614. The pressure roller 62 is in contact with the outer peripheral surface of the belt 614 and forms the fixing nip portion NP1 that pinches and conveys the sheet S together with the heater 611 via the belt 614.

The pressure roller 62 is rotationally driven by transmission of a driving force from the driving source of the image forming device 1. When the pressure roller 62 is rotationally driven, the belt 614 is rotated in a driven manner by a frictional force between the belt 614 and the pressure roller 62 or between the belt 614 and the sheet S pinched in the fixing nip portion NP1. The sheet S is pinched and conveyed while receiving heat and pressure in the fixing nip portion NP1, and the toner image formed on the sheet S is fixed onto the sheet S.

The fixing device 6 includes a lower frame 63 that supports the heating unit 61 and the pressure roller 62 and an upper frame 64, disposed above the lower frame 63, that covers the heating unit 61.

The upper frame 64 includes an upper sheet guide 64a that guides the upper surface of the sheet S conveyed along the conveyance path P on the downstream side in the sheet conveyance direction of the heating unit 61 and the pressure roller 62. The lower frame 63 includes a lower sheet guide 63a that guides the lower surface of the sheet S conveyed along the conveyance path P on the downstream side in the sheet conveyance direction of the heating unit 61 and the pressure roller 62.

The conveyance path P in the fixing device 6 extends substantially in the front-rear direction and is inclined upward toward the rear from the front. That is, the sheet conveyance direction in the fixing device 6 is substantially the front-rear direction.

It should be noted that the lower frame 63 and the upper frame 64 are formed of non-conductive molded members in this structure.

The lower frame 63 supports the heating unit 61 and the pressure roller 62. The lower frame 63 includes a pair of rails 63b at individual end portions in the longitudinal direction. The rails 63b movably support the holder 612 in a thickness direction of the heater via transmission members 617a and 617b that transmit pressure to the stay 613.

The rails 63b are columnar portions that extend in the thickness direction of the heater from a main body 63c of the lower frame 63. The pair of rails 63b faces each other in the sheet conveyance direction. The surfaces of the rails 63b that face each other are engaged with groove portions 617a1 and 617b1 provided in the transmission members 617a and 617b, respectively. It should be noted that the rails 63b are columnar portions extending in the thickness direction of the heater in the present example. However, the rails 63b only need to have a shape that can movably support the holder 612 in in the thickness direction of the heater, and the present disclosure is not limited to the shape of the present example.

Respective end portions in the longitudinal direction of the metal shaft 62a of the pressure roller 62 are rotatably held by the lower frame 63 via bearings 62c and 62d. At this time, a projecting portion 62c1 provided in the bearing 62c fits into a recessed portion 63d1 provided in the lower frame 63 to determine the position of the bearing 62c. Similarly, a projecting portion 62d1 provided in the bearing 62d fits into a recessed portion 63d2 provided in the lower frame 63 to determine the position of the bearing 62d. The bearing 62c is formed of a conductive material.

The projecting portions 62c1 and 62d1 are provided in the bearings 62c and 62d, and the recessed portions 63d1 and 63d2 are provided in the lower frame 63 in this structure. However, the relationship between the projecting portions and recessed portions is not so limited. For example, the shape of the unit for fixing the bearings 62c and 62d to the lower frame 63 is not limited to a concave-convex shape.

It should be noted that the pressure roller 62 includes the shaft 62a and the rubber roller 62b in the present example, but the present disclosure is not limited to this structure and the pressure roller 62 can also include a pressure belt that is pressed against the heating roller by an elastic member.

### Pressure Release Mechanism

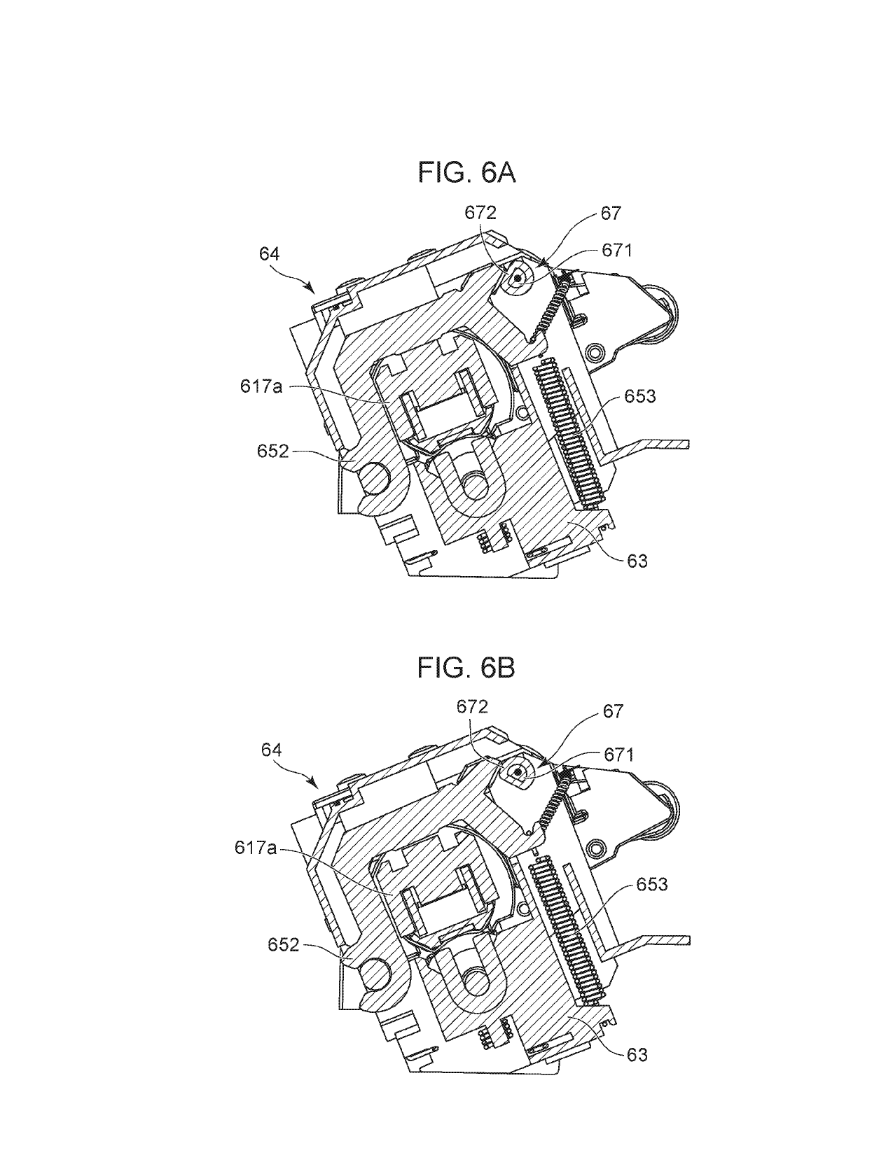

As illustrated in FIGS. 6A and 6B, the fixing device 6 includes a pressure release mechanism 67 for releasing the nip pressure in the nip portion NP1 between the heating unit 61 and the pressure roller 62. The pressure release mechanism 67 includes a camshaft 671 and cams 672. The lower frame 63 supports a pressure spring 653 and pivotably supports the pressure arm 652 and the cam 672.

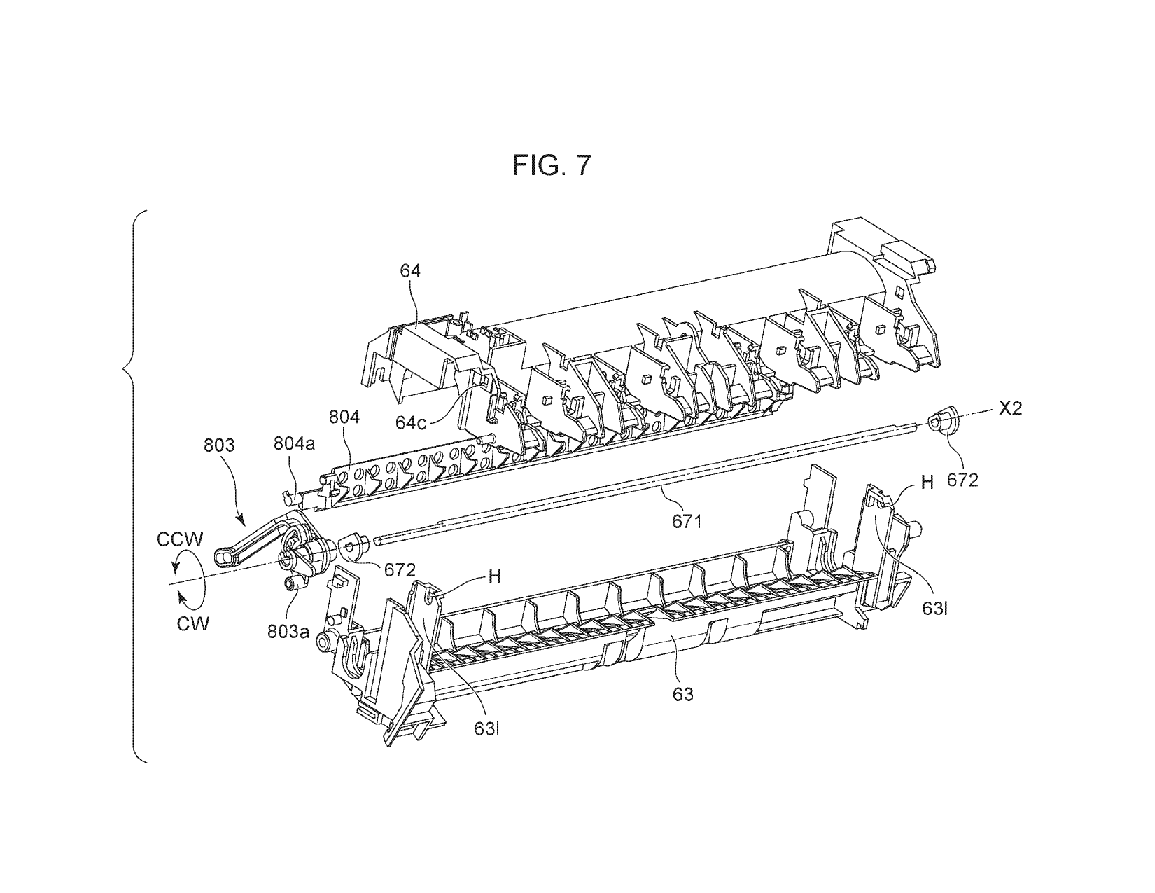

The cams 672 are located at both end portions of the lower frame 63 in the longitudinal direction. Since the structure on one side in the longitudinal direction of the heater of the pressure release mechanism 67 is substantially the same as the structure on the other side, the description of structure on one side in the longitudinal direction of the heater applies to each side and is not repeated for conciseness. As illustrated in FIG. 7, the camshaft 671 extends in the longitudinal direction of the heater. The camshaft 671 is made of, for example, a metal. The cams 672 are fixed to the end portions of the camshaft 671 in the axial direction. In other words, the cams 672 have the camshaft 671. The cams 672 pivot as the camshaft 671 pivots. The lower frame 63 includes support portions 63l that pivotably support the camshaft 671. The support portions 63l are disposed at one end portion and the other end portion of the lower frame 63 in the longitudinal direction of the heater. Each of the support portions 63l has a hole H that pivotably supports the camshaft 671.

The upper frame 64 has grooves 64C that pivotably support the camshaft 671. Each of the grooves 64C is disposed at a respective end portion of the upper frame 64 in the longitudinal direction of the heater 611. The camshaft 671 is held between the upper frame 64 and the lower frame 63.

As illustrated in FIG. 7, the camshaft 671 is pivotably supported about an axis X2.

The cams 672 are capable of pressing the pressure arm 652 against the urging force of the pressure spring 653. Specifically, the cams 672 are pivotable between a first position in the pressurized state illustrated in FIG. 6A and a second position in the pressure release state illustrated in FIG. 6B.

### Fixing Shutter

The fixing device 6 includes a fixing shutter 804, as illustrated in FIG. 7, which is provided to prevent the user from receiving electric shock or burns and image defects due to contamination that may occur when the user accesses the nip portion NP1 formed by the heating unit 61 and the pressure roller 62.

The fixing shutter 804 includes a shutter link 803 and the fixing shutter 804. The shutter link 803 is supported coaxially with the camshaft 671 so as to rotate integrally with the camshaft 671 and the cams 672.

The fixing shutter 804 is supported pivotably with respect to the fixing device 6, and a shutter shaft 804a is engaged with a link hole 803a of the shutter link 803. The shutter link 803 may be configured as a single component or a plurality of components.

The pressure release mechanism and the fixing shutter described above are interlocked with the open-close operation of the open-close door 21. The interlock with the open-close door 21 is achieved, for example, by coupling the open-close door 21 and the link hole 803a via an intermediate link. The shutter link 803 and the cams 672 rotate clockwise (CW) or counterclockwise (CCW) together with the camshaft 671 by being interlocked with the pivot operation of the open-close door 21.

When the open-close door 21 is in a closed state, the fixing device 6 is in the pressurized state (FIG. 6A), and the fixing shutter 804 is at an open position. On the other hand, when the open-close door 21 is in an open state, the fixing device 6 is in a pressure release state (FIG. 6B), and the fixing shutter 804 is at a shielding position.

### Heater Wiring

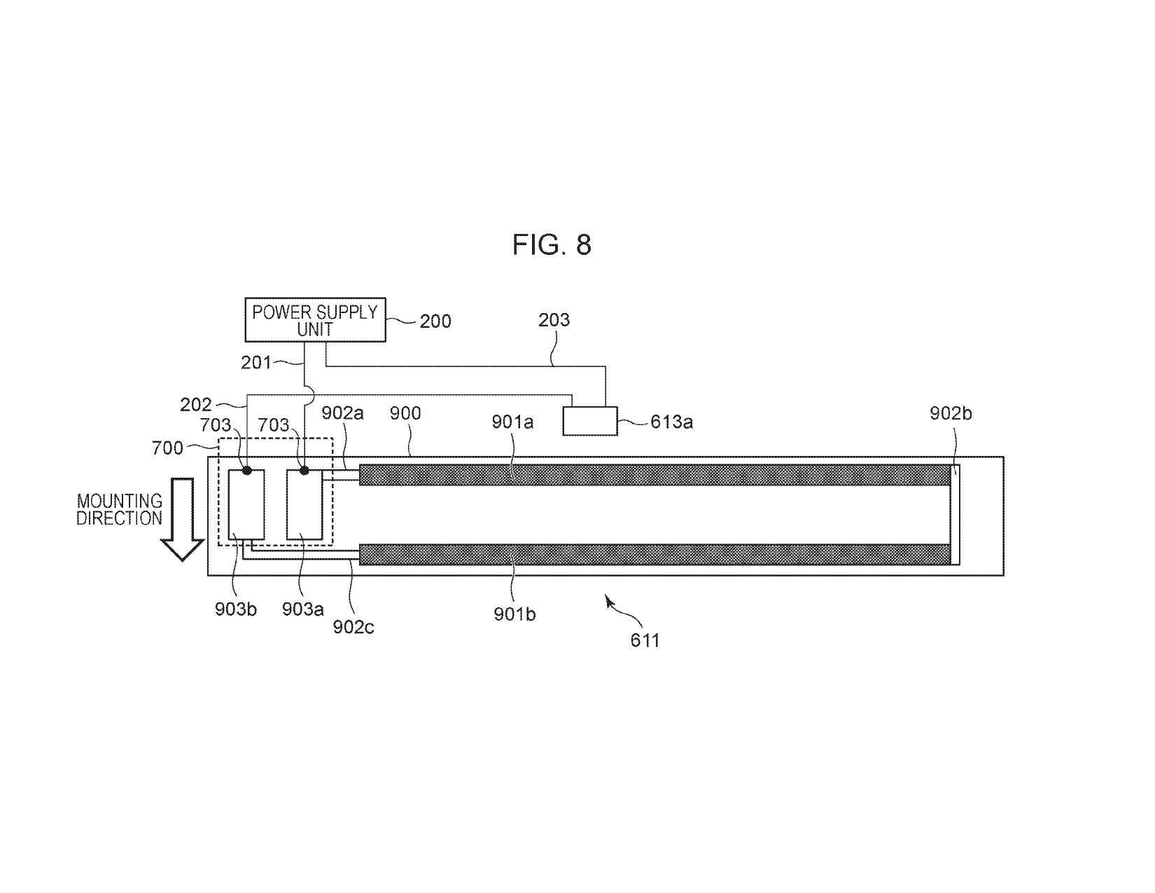

As illustrated in FIG. 8, the heater 611 includes a plate-like board 900, heat generating resistors 901a and 901b formed on the board 900, conductors 902a, 902b and 902c, and electrodes 903a and 903b. The material of the board 900 is ceramic or insulated stainless steel.

One end of the conductor 902a is connected to the electrode 903a for the heat generating resistor, and the other end is connected to the heat generating resistor 901a. One end of a conductor 902b is connected to the heat generating resistor 901a, and the other end is connected to the heat generating resistor 901b. One end of the conductor 902c is connected to the heat generating resistor 901b, and the other end is connected to the electrode 903b for the heat generating resistor. Accordingly, a heater circuit structure is provided in which the heat generating elements 901a and 901b generate heat at the same time by receiving power between the electrodes 903a and 903b for the heat generating resistors.

The power supply to the heater 611 is performed via a connector 700 electrically connected to the heater 611 and cables (power supply cables) 201 and 202 connected to the connector 700. The cable 201 is connected to the connector 700 and a power supply unit 200. The cable 202 is connected to a thermostat 613a from the connector 700. In addition, a cable 203 connects the thermostat 613a and the power supply unit 200. The thermostat 613a is a switch that cuts off the circuit when its temperature exceeds a threshold. The thermostat 613a is connected in series between the power supply unit 200 and the heater 611 and is provided at a position heated by the heater 611. When the heater 611 reaches a temperature higher than a threshold, the thermostat 613a operates to open the circuit between the heater 611 and the power supply unit 200, thereby preventing the temperature of the heater 611 from exceeding the threshold.

### Connector and Connector Cap

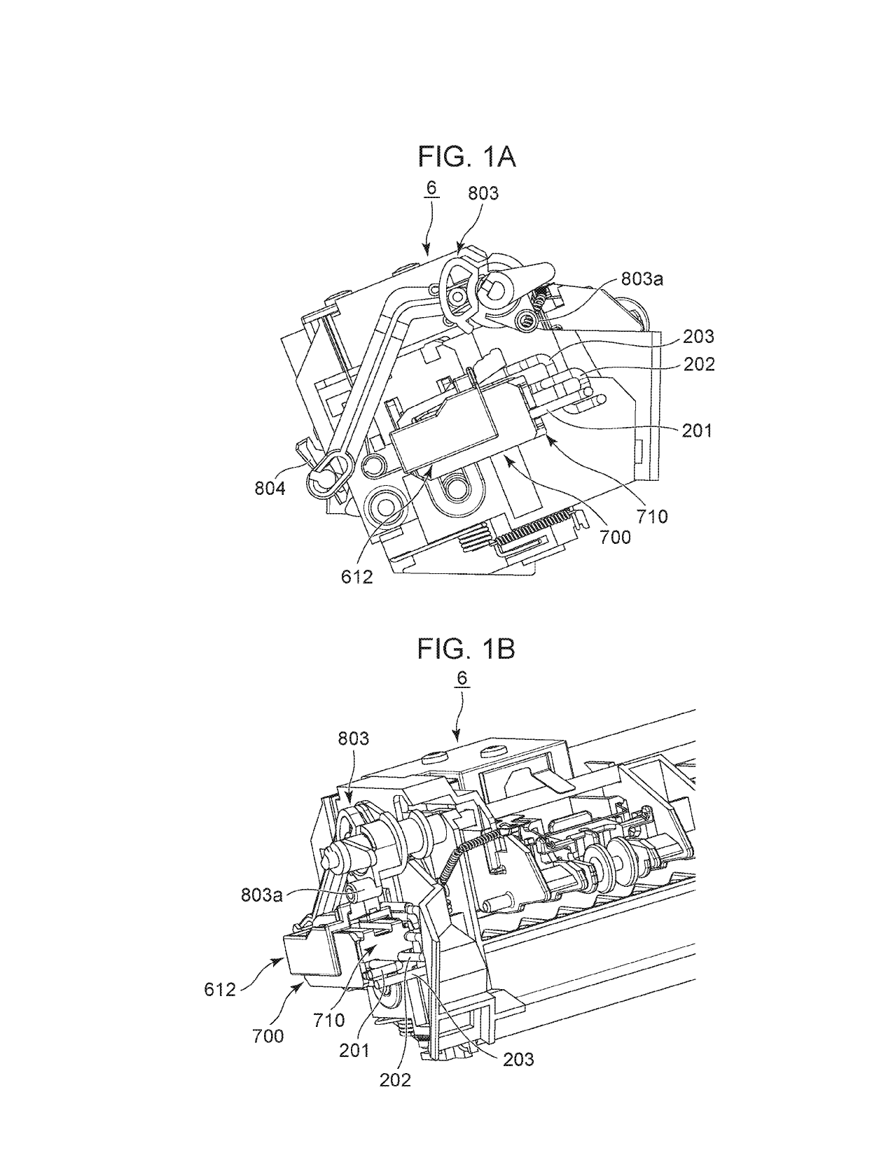

The connector (power supply connector) 700 and the connector cap 710 will be described with reference to FIGS. 1A and 1B and FIGS. 9A to 11B.

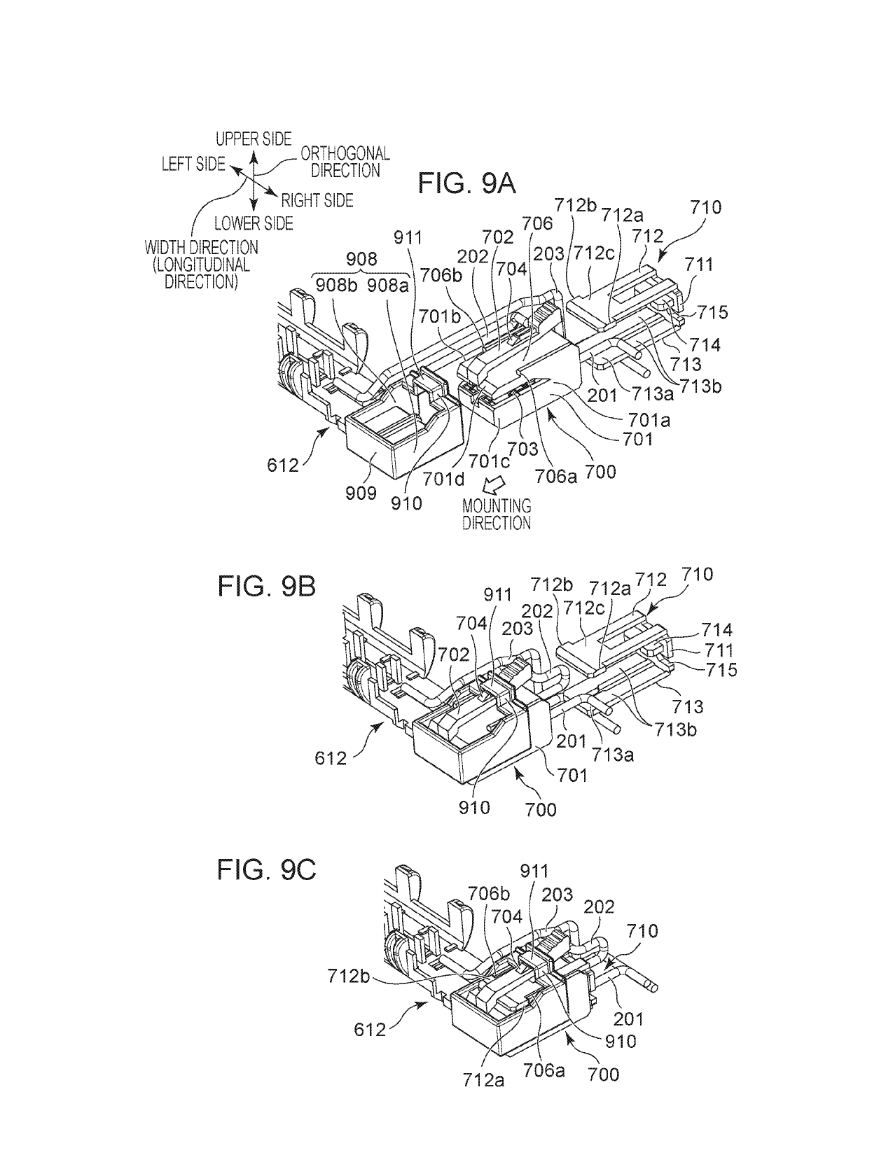

FIGS. 1A and 1B are diagrams illustrating the structure of the fixing device 6. FIG. 1A is a right-side view, and FIG. 1B is a perspective view. FIGS. 9A to 9C are perspective views of one end portion of the holder 612 in the longitudinal direction, the connector 700, and the connector cap 710 as viewed from the front right. FIG. 9A illustrates the state in which the connector 700 and the connector cap 710 are not yet mounted, FIG. 9B illustrates the state in which the connector 700 has been mounted to the holder 612, and FIG. 9C illustrates the state in which the connector 700 and the connector cap 710 have been mounted.

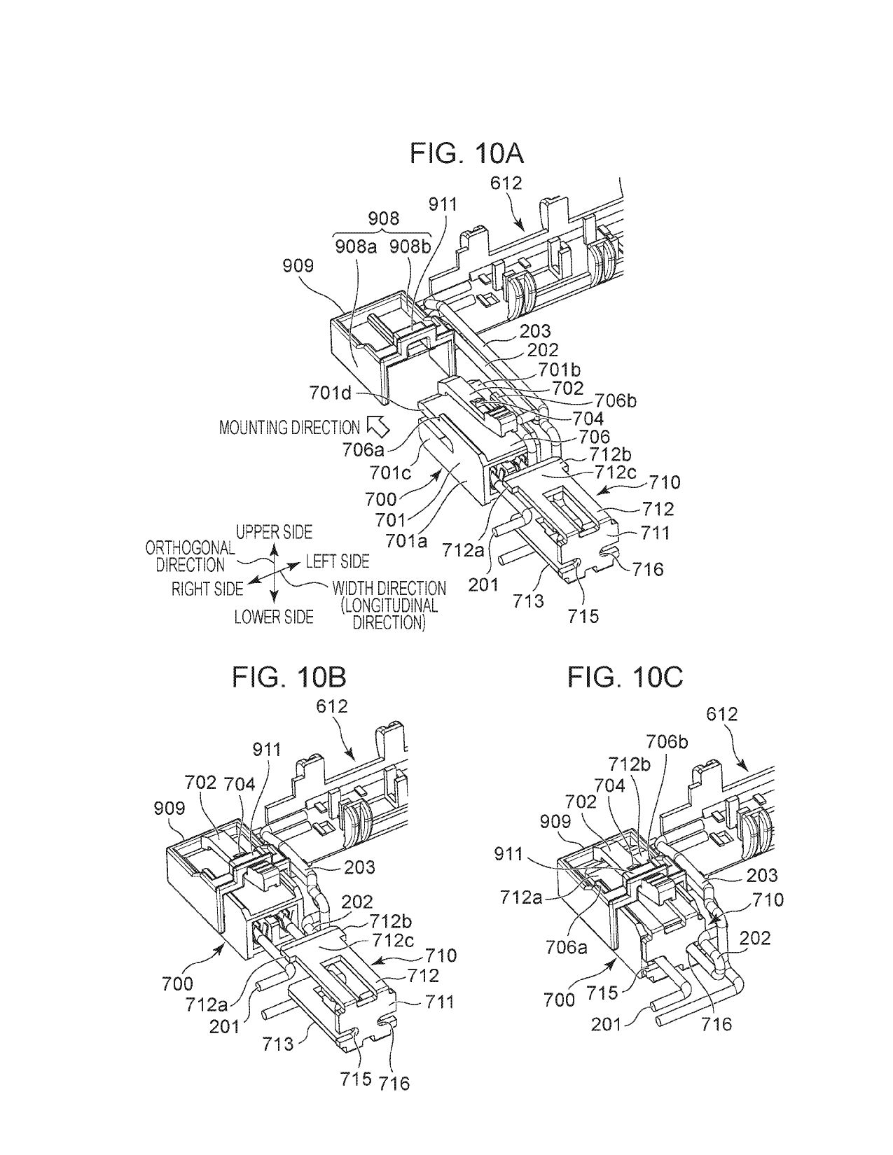

FIGS. 10A to 10C are perspective views of one end portion of the holder 612 in the longitudinal direction, the connector 700, and the connector cap 710 as viewed from the rear right. FIG. 10A illustrates the state in which the connector 700 and the connector cap 710 are not yet mounted, FIG. 10B illustrates the state in which the connector 700 has been mounted to the holder 612, and FIG. 10C illustrates the state in which the connector 700 and the connector cap 710 have been mounted.

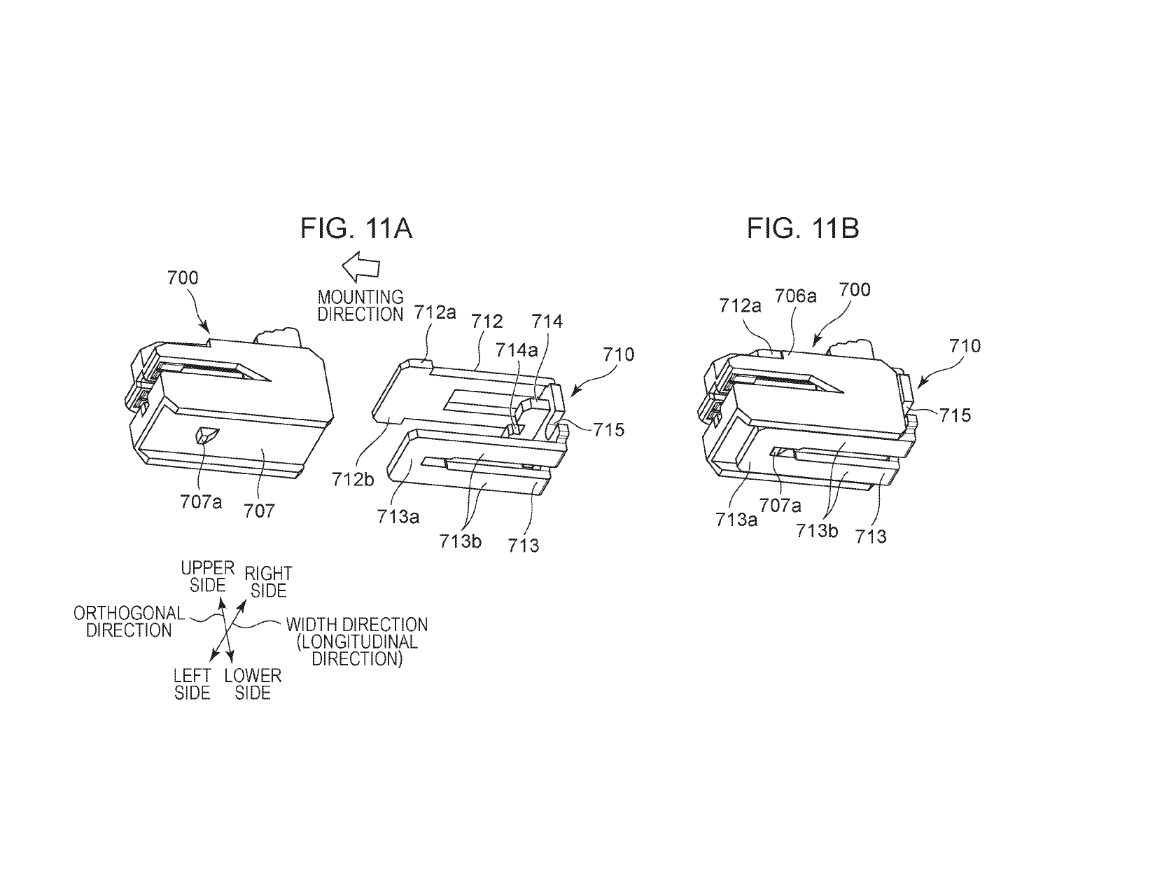

FIGS. 11A to 11B are perspective views of the connector 700 and the connector cap 710 as viewed from below. FIG. 11A illustrates the state in which the connector 700 and the connector cap 710 are not yet mounted, FIG. 11B illustrates the state in which the connector cap 710 has been mounted to the connector 700.

### Connector

As illustrated in FIGS. 9A to 10C, the connector 700 is mounted to one end portion of the holder 612 in the longitudinal direction from one side of the heater 611 to the other side in the lateral direction. The width direction of the connector 700 is the same as the longitudinal direction of the heater 611 in the state in which the connector 700 has been mounted to the holder 612.

The connector 700 includes an arm portion 702 and a housing 701 made of a non-conductive material, such as resin, and a pair of contacts 703, housed in the housing 701, that is made of a conductive material, such as metal. The arm portion 702 includes a claw portion 704. When the connector 700 is mounted, each contact of the pair of contacts 703 (see FIG. 8) is in contact with a respective one of the electrodes 903a and 903b. FIG. 9A shows one of the pairs of contacts 703 shown in FIG. 8. As a result, power can be supplied from the power supply unit 200 to the heat generating elements 901a and 901b through the electrodes 903a and 903b.

The housing 701 has a shape that sandwiches the one end portion of the holder 612 in the longitudinal direction and the one end portion of the heater 611 in the longitudinal direction in the state in which the connector 700 has been mounted to the holder 612. The housing 701 has a first side surface 701a and a second side surface 701b that intersect the longitudinal direction of the holder 612, and a first extending portion 701c and a second extending portion 701d that extend toward the heater 611 from the first side surface 701a and the second side surface 701b.

The arm portion 702 is located on one side of the housing 701 in an orthogonal direction with respect to a mounting direction of the connector 700 and extends in the mounting direction of the connector 700. The arm portion 702 is provided in the vicinity of the center of the connector 700 in the width direction of the connector 700. One end of the arm portion 702 in the mounting direction is connected to the housing 701, and the other end is elastically bent in a direction approaching the housing 701.

The claw portion 704 is formed in the vicinity of the center of the arm portion 702 in the mounting direction so as to project in a direction away from the housing 701. The claw portion 704 has a surface, on the upstream side in the mounting direction, that is substantially orthogonal to the mounting direction, and a surface, on the downstream side in the mounting direction, that is inclined so as to approach the arm portion 702 toward the downstream side from the upstream side in the mounting direction.

The holder 612 includes a pair of wall portions 908, a connecting wall portion 909, and a connecting portion 910 that connects the pair of wall portions 908 to each other. The pair of wall portions 908, the connecting wall portion 909, and the connecting portion 910 are formed integrally with one end portion of the holder 612 in the longitudinal direction.

The pair of wall portions 908 faces each other in a direction orthogonal to the mounting direction of the connector 700. The pair of wall portions 908 is provided so as to sandwich the connector 700 therebetween in the state in which the connector 700 is mounted to the holder 612. In the longitudinal direction of the heater 611, the spacing between the pair of wall portions 908 is slightly greater than the length of the connector 700 in the width direction. The pair of wall portions 908 includes a wall portion 908a located as one of the pair of wall portions 908 on one side in the longitudinal direction and a wall portion 908b located as the other of the pair of wall portions 908 on the other side in the longitudinal direction.

The connecting wall portion 909 connects the end portions of the pair of wall portions 908 (908a and 908b) to each other on the downstream side in the mounting direction.

The connection portion 910 connects the end portions of the pair of wall portions 908 on the upstream side in the mounting direction. In addition, a retaining portion 911 that functions as a mechanism for retaining the connector 700 is provided in the vicinity of the center of the connection portion 910.

As illustrated in FIG. 9B, when the connector 700 is mounted to the holder 612, the arm portion 702 is elastically bent so as to approach the housing 701, and the claw portion 704 comes into contact with the retaining portion 911 of the holder 612. At this time, the claw portion 704 is engaged with the retaining portion 911, and accordingly, the retaining portion 911 restricts the connector 700 from moving to the upstream side in the mounting direction of the connector 700.

In addition, in the housing 701, one end portion of the heater 611 in the longitudinal direction is sandwiched by the first extending portion 701c via the contact 703, and one end portion of the holder 612 in the longitudinal direction is sandwiched by the second extending portion 701d.

### Connector Cap

As illustrated in FIGS. 9A to 11B, the connector cap 710 includes a cover wall 711, a first wall 712, and a second wall 713, which form a U-shape, and a positioning portion 714.

The cover wall 711 covers the upstream side of the connector 700 in the mounting direction in the state in which the connector cap 710 has been attached to the connector 700. As a result, the cover wall 711 covers the upstream side of the contact 703 in the mounting direction in the state in which the connector cap 710 has been attached to the connector 700.

As illustrated in FIGS. 9A to 10C, the cover wall 711 has a first cutaway portion 715 and a second cutaway portion 716. The first cutaway portion 715 and the second cutaway portion 716 provide openings through which the cables 201 and 202, respectively, connected to the contact 703 of the connector 700 pass. The first cutaway portion 715 and the second cutaway portion 716 have U-shapes along substantially half the circumferences of the cables 201 and 202 as viewed in the mounting direction of the connector 700 with respect to the heater 611. The opening of the first cutaway portion 715 is oriented to the right side, and the opening of the second cutaway portion 716 is oriented to the left side. The cables 201 and 202 can be inserted into the cutaway portions 715 and 716 through the openings of the cutaway portions 715 and 716, respectively.

The first wall 712 extends from the end on one side of the cover wall 711 in the orthogonal direction toward the downstream side in the mounting direction, and the second wall 713 extends from the end on the other side of the cover wall 711 in the orthogonal direction toward the downstream side in the mounting direction. When the connector cap 710 is attached to the connector 700, the housing 701 of the connector 700 is sandwiched between the second wall 713 and the first wall 712.

The first wall 712 includes a pair of first engaging portions 712a and 712b. The first engaging portions 712a and 712b restrict the connector cap 710 from moving to the upstream side in the mounting direction by being engaged with the housing 701 of the connector 700. The first wall 712 includes an arm 712c that extends from the end on one side of the cover wall 711 in the orthogonal direction toward the downstream side in the mounting direction. The first engaging portion 712a projects from the leading end portion of the arm 712c toward the right side of the connector 700, and the first engaging portion 712b projects from the leading end portion of the arm 712c toward the left side of the connector 700.

The connector 700 includes a first rib 706a and a second rib 706b that project outward in the orthogonal direction from the left and right end portions of the upper surface 706 and extend in the mounting direction. The first rib 706a and the second rib 706b extend from the vicinity of the central portion of the housing 701 in the mounting direction to the vicinity of the end portion on the upstream side.

The first engaging portion 712a is engaged with the first rib 706a and the first engaging portion 712b is engaged with the second rib 706b when the connector cap 710 is attached to the connector 700, and accordingly, the first wall 712 restricts the connector cap 710 from moving to the upstream side in the mounting direction.

As illustrated in FIGS. 11A and 11B, the second wall 713 includes a second engaging portion 713a. The second engaging portion 713a restricts the connector cap 710 from moving to the upstream side in the mounting direction by being engaged with the housing 701 of the connector 700. The second wall 713 includes a pair of extending portions 713b that extend from the end on the other side of the cover wall 711 in the orthogonal direction to the downstream side in the mounting direction. The pair of extending portions 713b are spaced apart in the width direction of the connector 700. The second engaging portion 713a is provided to connect the leading end portions of the pair of extending portions 713b to each other.

The second wall 713 has a substantially U-shape with the end portion on the downstream side in the mounting direction closed.

The connector 700 includes a second claw portion 707a that projects downward from the vicinity of the central portion of the lower surface 707 in the mounting direction. The second claw portion 707a has a surface, on the downstream side in the mounting direction, that is substantially orthogonal to the mounting direction and a surface, on the upstream side in the mounting direction, that is inclined so as to be away from the lower surface 707 toward the downstream side from the upstream side in the mounting direction. The second engaging portion 713a is engaged with the second claw portion 707a when the connector cap 710 is attached to the connector 700, and accordingly, the second wall 713 restricts the connector cap 710 from moving to the upstream side in the mounting direction. The connector cap 710 is elastically attached to the housing 701 by snap-fit due to the elasticity of the pair of extending portions 713b.

The connector cap 710 is made of a heat-resistant resin, such as polyamide resin (PA66) or liquid crystal polymer (LCP). Since the heat-resistant resin is relatively hard, the resin is less likely to elastically deform. Accordingly, to ensure the ease of elastic deformation of the first wall 712 and the second wall 713 when the connector cap 710 is attached to the connector 700, the first wall 712 and the second wall 713 are formed in plate shapes, and the lengths in the mounting direction are sufficiently long in this example.

### Effects

In example 1 described above, in the state in which the cables 201 and 202 have been connected to the connector 700, the cables 201 and 202 can pass through the first cutaway portion 715 and the second cutaway portion 716, respectively, of the connector cap 710. As a result, after the connector 700 is mounted to the holder 612, the connector cap 710 can be attached to the connector 700.

The openings of the first cutaway portion 715 and the second cutaway portion 716 are oriented to the right side and the left side, respectively, but the openings may also be oriented to, for example, the upper side and the lower side. In addition, two cutaway portions through which the cables 201 and 202 pass, that is, the first cutaway portion 715 and the second cutaway portion 716, have been provided, but a single cutaway portion through which the cables 201 and 202 pass may be provided.

### Example 2

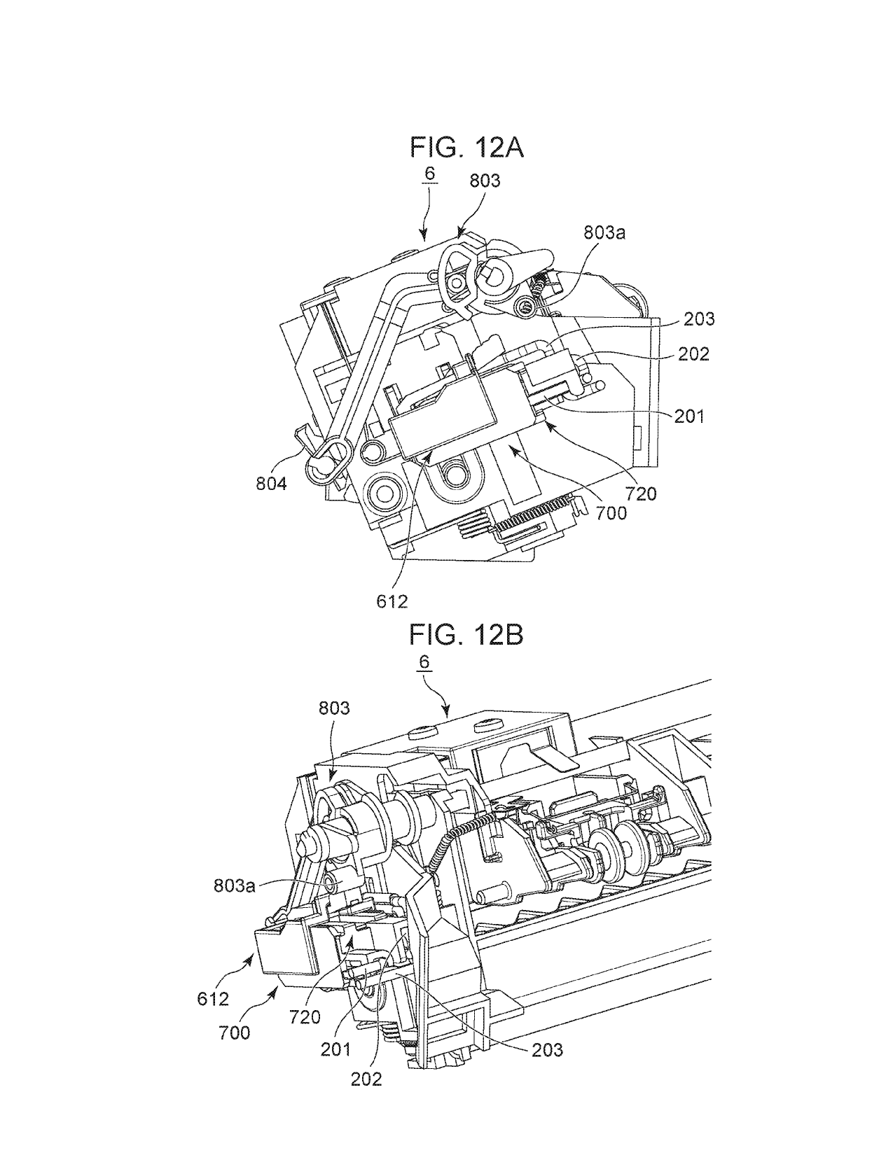

Example 2 will be described with reference to FIGS. 12A to 15C. The description of components and functions that are similar to those in example 1 is incorporated by reference here, for conciseness.

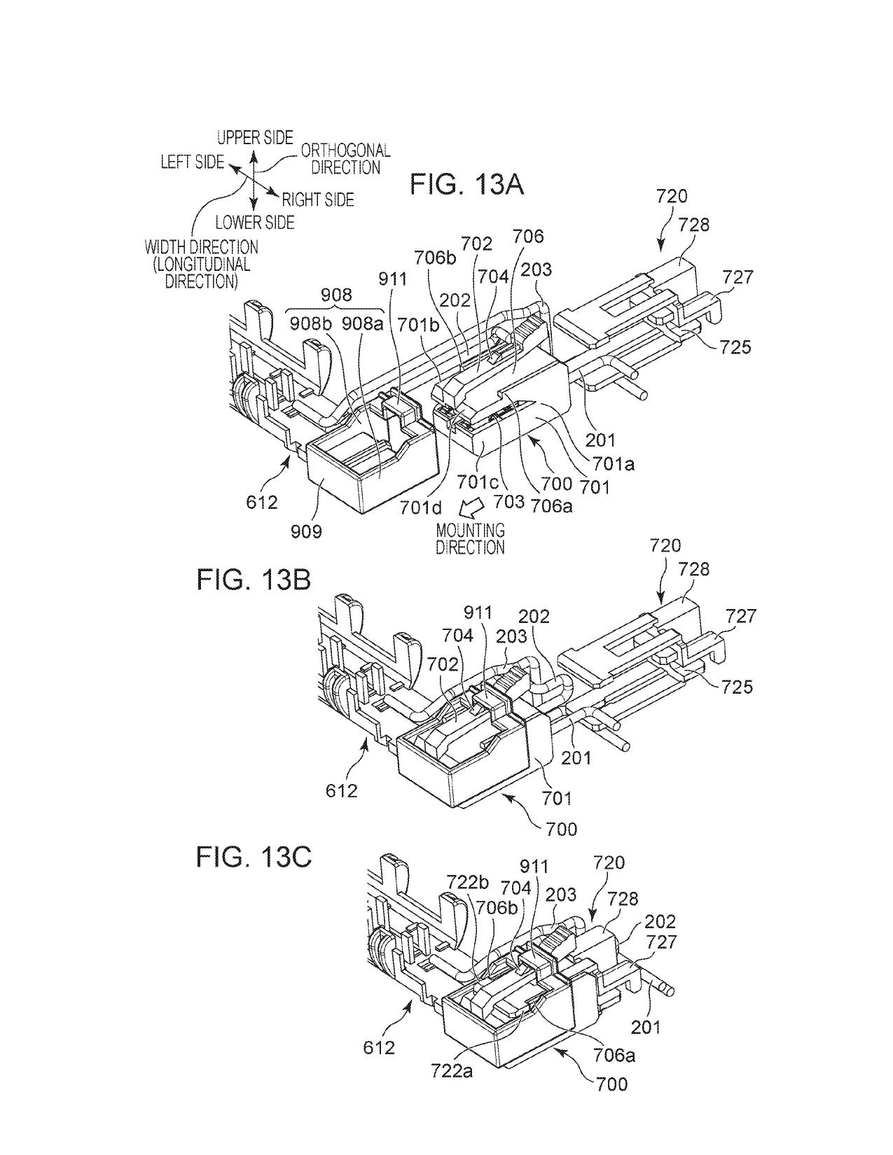

FIGS. 12A and 12B are diagrams of the fixing device 6 according to example 2 as viewed from the right side. FIG. 12A is a right-side view, and FIG. 12B is a perspective view. FIGS. 13A to 13C are perspective views of one end portion of the holder 612 in the longitudinal direction, the connector 700, and the connector cap 720 as viewed from the front right. FIG. 13A illustrates the state in which the connector 700 and the connector cap 720 are not yet mounted, FIG. 13B illustrates the state in which the connector 700 has been mounted to the holder 612, and FIG. 13C illustrates the state in which the connector 700 and the connector cap 720 have been mounted.

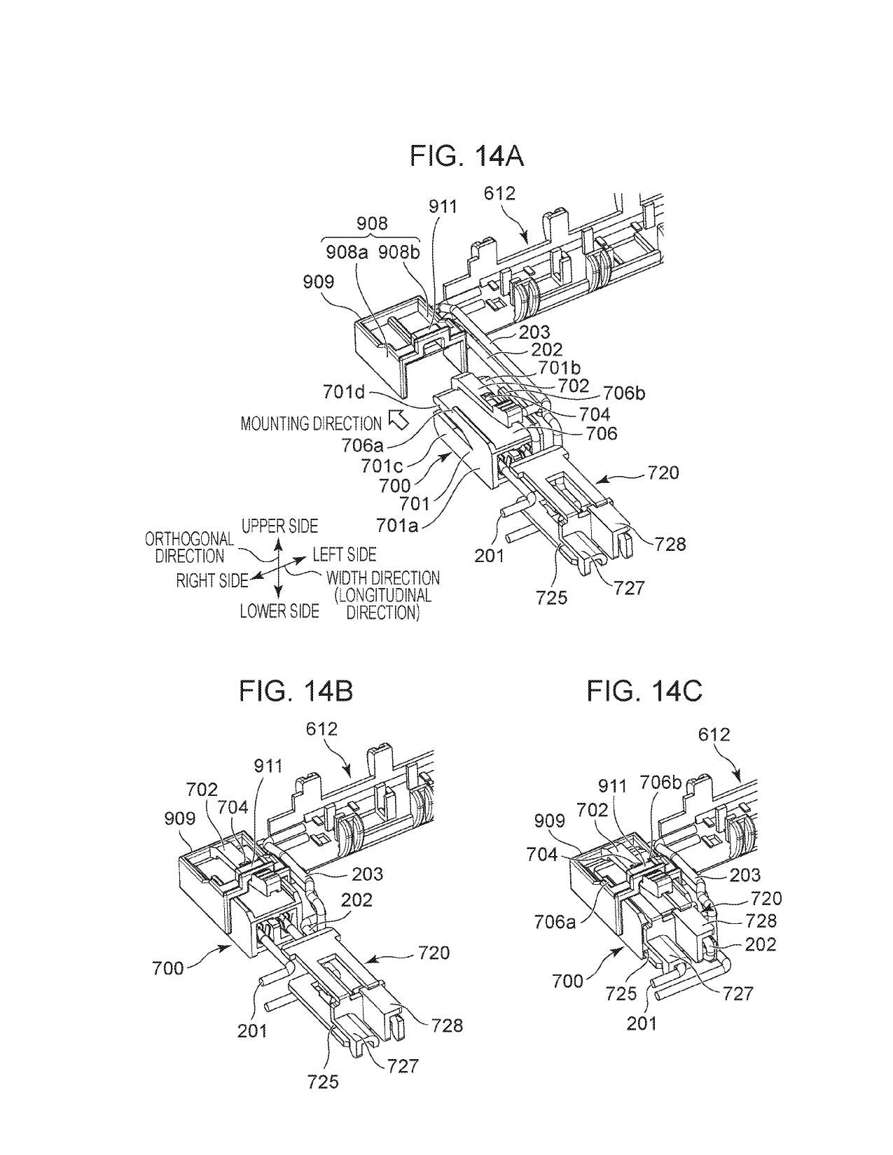

FIGS. 14A to 14C are perspective views of one end portion of the holder 612 in the longitudinal direction, the connector 700, and the connector cap 720 as viewed from the rear right. FIG. 14A illustrates the state in which the connector 700 and the connector cap 720 are not yet mounted, FIG. 14B illustrates the state in which the connector 700 has been mounted to the holder 612, and FIG. 14C illustrates the state in which the connector 700 and the connector cap 720 have been mounted.

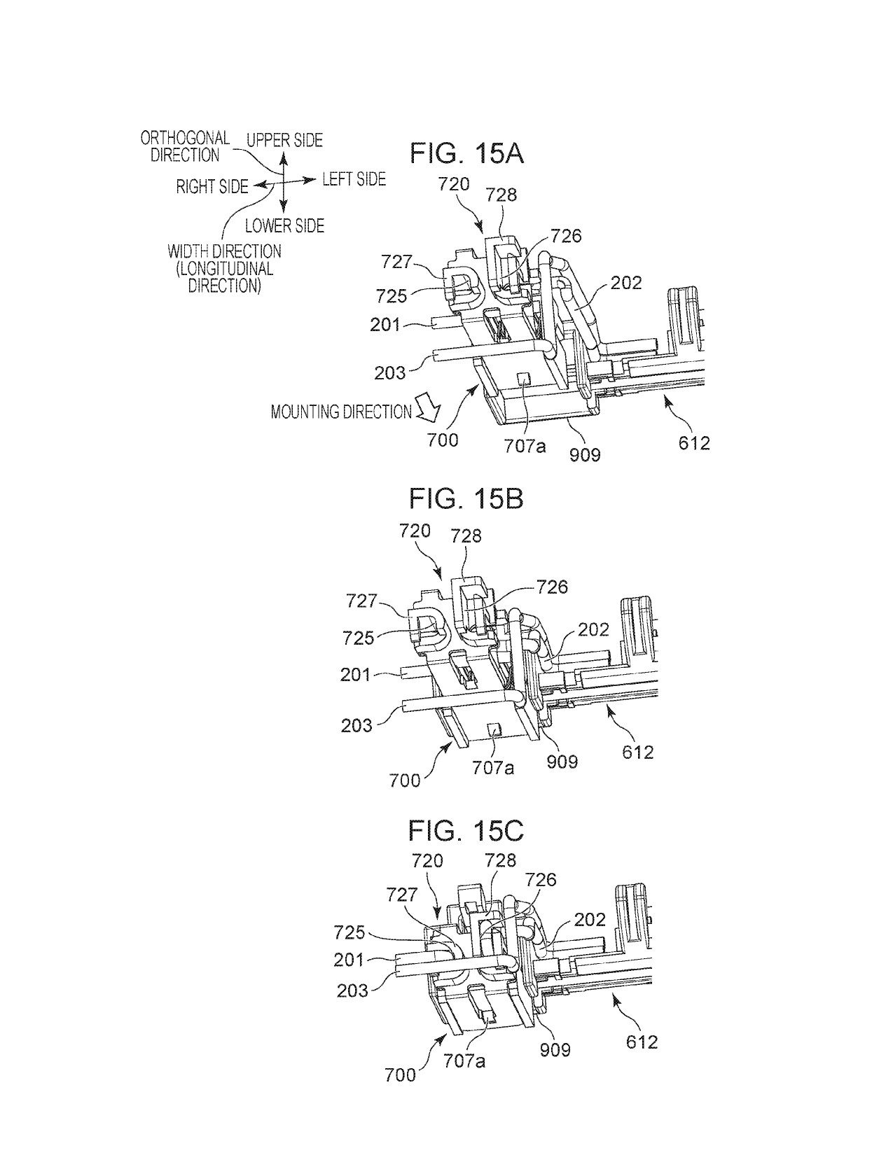

FIGS. 15A to 15C are perspective views of one end portion of the holder 612 in the longitudinal direction, the connector 700, and the connector cap 720 as viewed from below. FIG. 15A illustrates the state in which the connector 700 and the connector cap 720 are not yet mounted, FIG. 15B illustrates the state in which the connector 700 has been mounted to the holder 612, and FIG. 15C illustrates the state in which the connector 700 and the connector cap 720 have been mounted.

The connector cap 720 of example 2 differs from the connector cap 710 of example 1 in that a first guide portion 727 and a second guide portion 728 are added. As illustrated in FIGS. 13A to 15C, the first guide portion 727 and the second guide portion 728 that project, in a direction opposite to the mounting direction, from a first cutaway portion 725 and a second cutaway portion 726 of the connector cap 720 are provided. The first guide portion 727 has the function of guiding the cable 201, and the second guide portion 728 has the function of guiding the cable 202. As described above, the connector cap 720 includes the guide portions 727 and 728 that guide the cables 201 and 202, respectively. The guide portions 727 and 728 project in a direction away from the contact 703 from portions in which the cutaway portions 725 and 726 are formed.

As illustrated in FIG. 7 and FIGS. 12A and 12B, movable components, such as the shutter link 803 and the link hole 803a, are present above the connector cap 720 and the cables 201 and 202. The presence of the first guide portion 727 and the second guide portion 728 prevents the cables 201 and 202 from coming into contact with the movable components, such as the shutter link 803 and the link hole 803a.

### Example 3

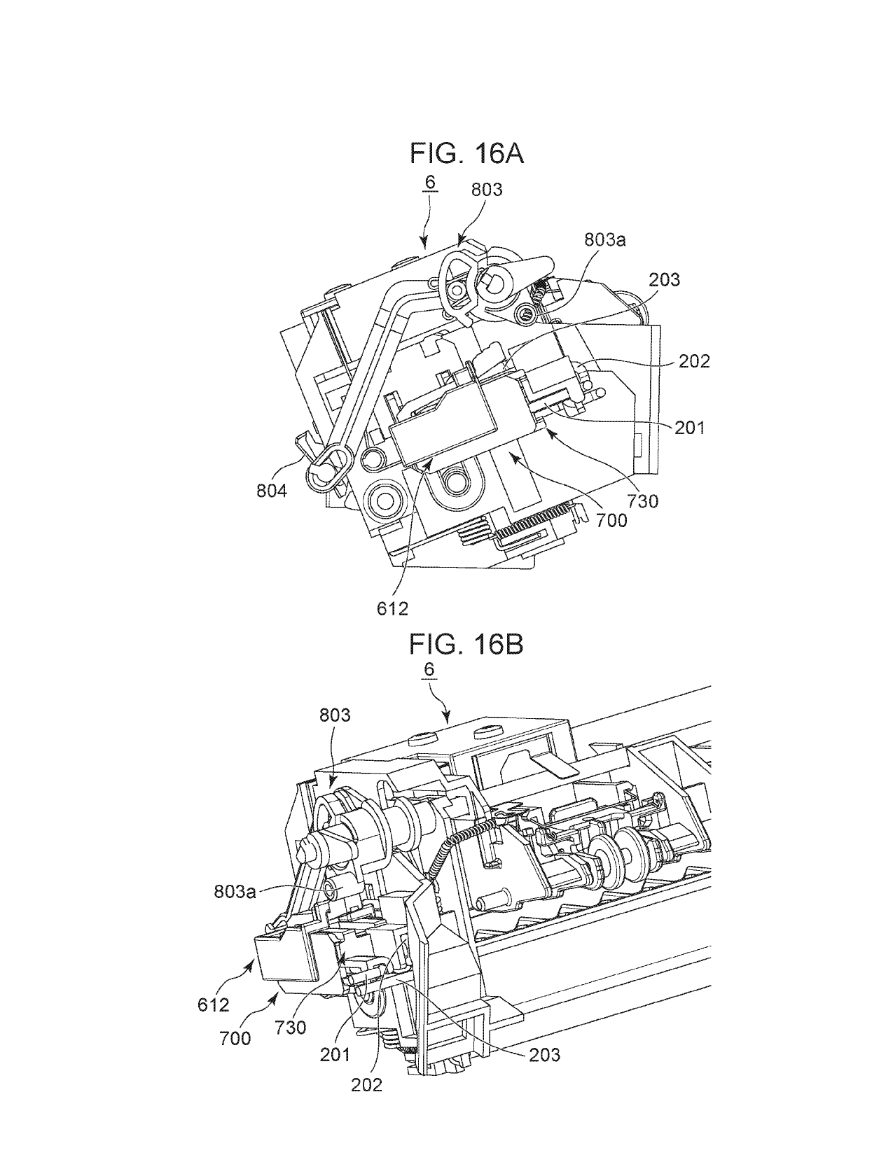

Example 3 will be described with reference to FIGS. 16A to 19C. The description of components and functions similar to those in examples 1 and 2 is incorporated by reference here, for conciseness.

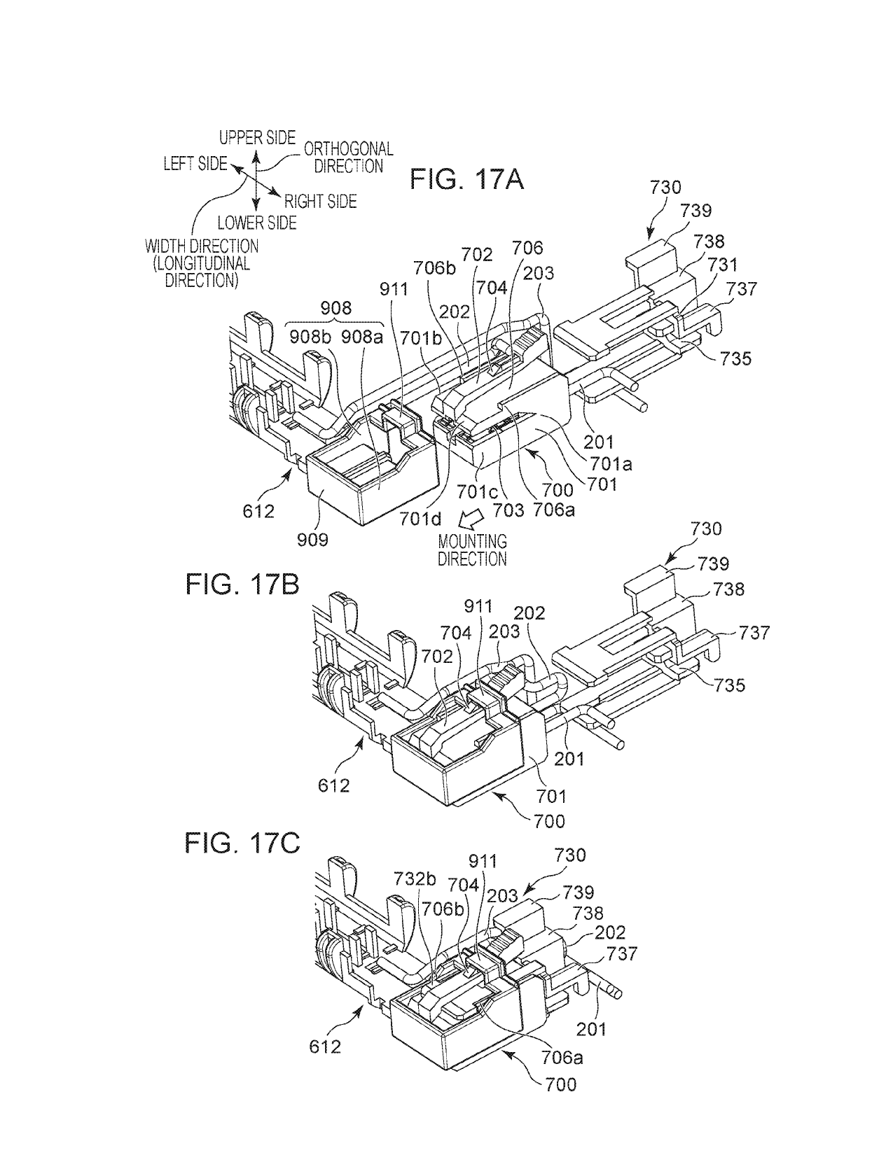

FIGS. 16A and 16B are diagrams of a fixing device 6 according to example 3 as viewed from the right side. FIG. 16A is a right-side view, and FIG. 16B is a perspective view. FIGS. 17A to 17C are perspective views of one end portion of the holder 612 in the longitudinal direction, the connector 700, and the connector cap 730 as viewed from the front right. FIG. 17A illustrates the state in which the connector 700 and the connector cap 730 are not yet mounted, FIG. 17B illustrates the state in which the connector 700 has been mounted to the holder 612, and FIG. 17C illustrates the state in which the connector 700 and the connector cap 730 have been mounted.

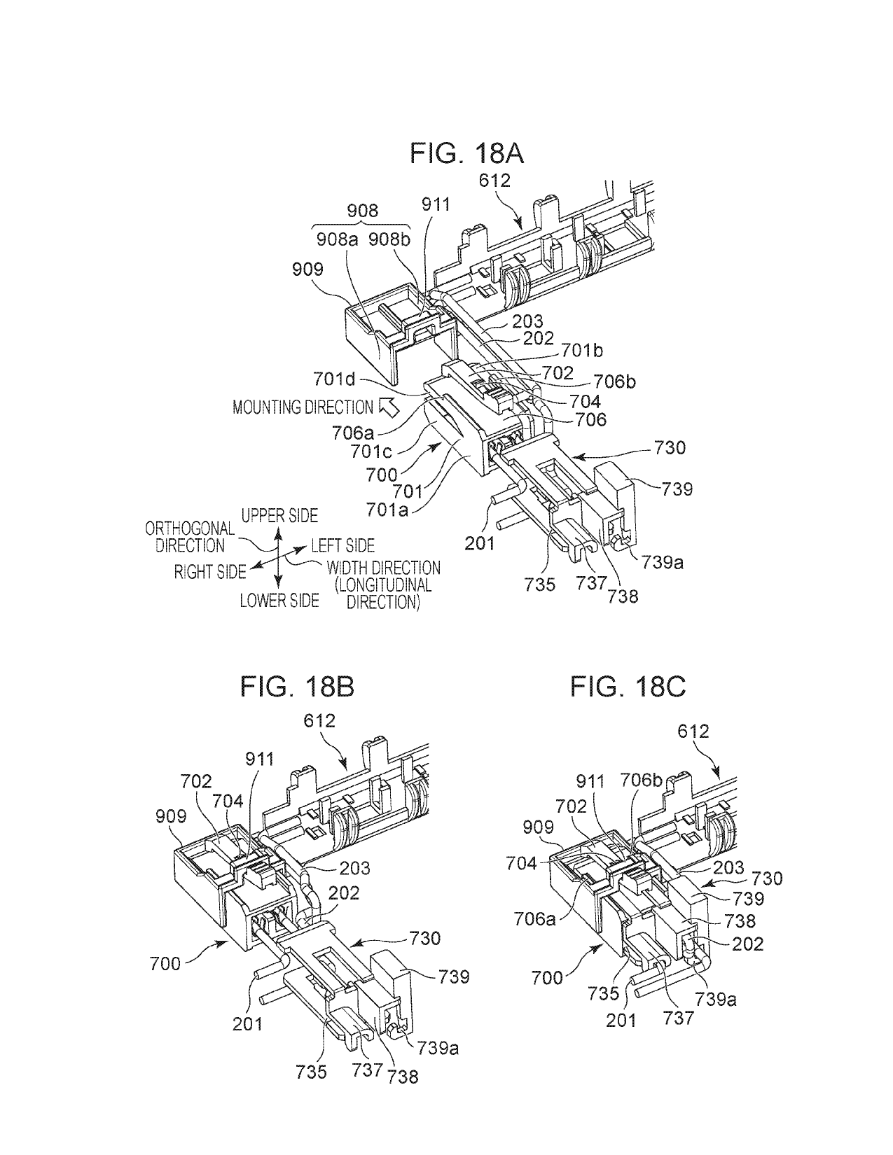

FIGS. 18A to 18C are perspective views of one end portion of the holder 612 in the longitudinal direction, the connector 700, and the connector cap 730 as viewed from the rear right. FIG. 18A illustrates the state in which the connector 700 and the connector cap 730 are not yet mounted, FIG. 18B illustrates the state in which the connector 700 has been mounted to the holder 612, and FIG. 18C illustrates the state in which the connector 700 and the connector cap 730 have been mounted.

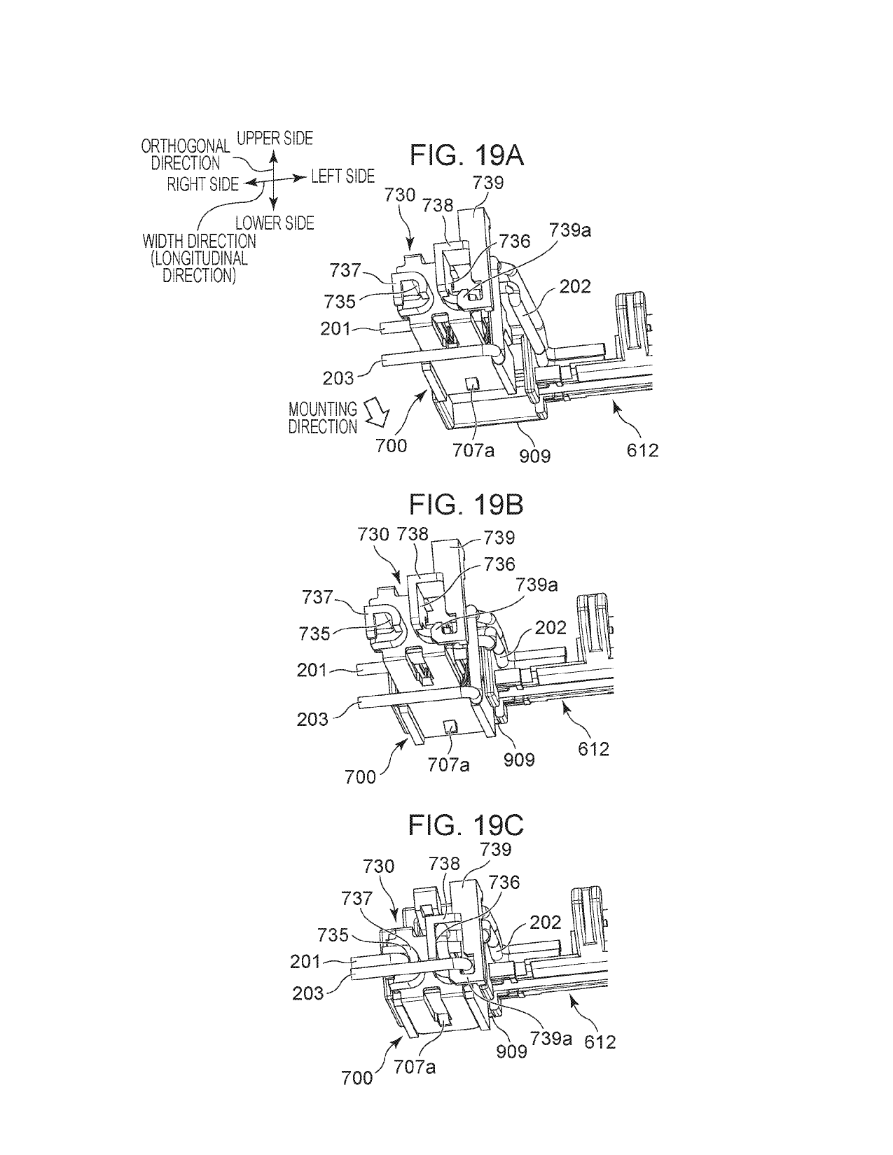

FIGS. 19A to 19C are perspective views of one end portion of the holder 612 in the longitudinal direction, the connector 700, and the connector cap 730 as viewed from below. FIG. 19A illustrates the state in which the connector 700 and the connector cap 730 are not yet mounted, FIG. 19B illustrates the state in which the connector 700 has been mounted to the holder 612, and FIG. 19C illustrates the state in which the connector 700 and the connector cap 730 have been mounted.

The connector cap 730 of example 3 differs from the connector cap 720 of example 2 in that a third guide portion 739 and a fourth guide portion 739a are added. As illustrated in FIGS. 17A to 19C, a first guide portion 737 and a second guide portion 738 that project in a direction opposite to the mounting direction from a first cutaway portion 735 and a second cutaway portion 736 of the connector cap 730 are provided.

The first guide portion 737 has the function of guiding the cable 201, and the second guide portion 738 has the function of guiding the cable 202. The third guide portion 739 is provided on the left side of the second guide portion 738 of the connector cap 730. In addition, the fourth guide portion 739a is provided below the third guide portion 739. The third guide portion 739 and the fourth guide portion 739a have the function of guiding the cable 203.

As illustrated in FIG. 7 and FIGS. 16A and 16B, movable components, such as the shutter link 803 and the link hole 803a, are present above the connector cap 730 and cables 201, 202, and 203. The presence of the first guide portion 737, the second guide portion 738, the third guide portion 739, and the fourth guide portion 739a can prevent the cables 201, 202, and 203 from coming into contact with the movable components, such as the shutter link 803 and the link hole 803a.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-209699, filed December 2, 2024, which is hereby incorporated by reference herein in its entirety.

What is claimed is:

1. A fixing device comprising:
a fixing belt;
a heater that includes a board, a resistor provided in a longitudinal direction on an end portion of the board, and an electrode;
a holder disposed in an internal space of the fixing belt and configured to hold the heater in the longitudinal direction;
a power supply connector configured to supply power to the heater, the power supply connector including a contact configured to conductively contact the electrode, a housing configured to accommodate the contact, and a power supply cable connected to the contact; and
a connector cap configured to mount to the power supply connector,
wherein the connector cap has a cutaway portion configured for the power supply cable to pass through, and
wherein the power supply cable is configured to be insertable into the cutaway portion.

2. The fixing device according to claim 1,
wherein the cutaway portion has a U-shape, viewed in a mounting direction of the power supply connector with respect to the heater.

3. The fixing device according to claim 2,
wherein the mounting direction is orthogonal to the longitudinal direction.

4. The fixing device according to claim 1,
wherein the connector cap includes a guide portion configured to guide the power supply cable and projects in a direction away from the contact from a portion in which the cutaway portion is formed.

5. The fixing device according to claim 1,
wherein the connector cap is elastically attached to the housing.

6. The fixing device according to claim 1,
wherein the connector cap is attached to the housing by snap-fit.

7. The fixing device according to claim 1, further comprising:
a pressure roller configured to contact an outer peripheral surface of the fixing belt, to form a fixing nip portion, together with the heater.

8. The fixing device according to claim 7,
wherein the fixing nip portion is configured to pinch and convey the recording material together with the heater through the fixing belt.

9. The fixing device according to claim 7,
wherein the electrode is electrically connected to the resistor, which is configured to generate heat.

10. The fixing device according to claim 1,
wherein the fixing belt is cylindrically shaped.

11. The fixing device according to claim 1,
wherein the heater is disposed in the internal space of the fixing belt.

12. The fixing device according to claim 1,
wherein the board has a plate-like shape.

13. The fixing device according to claim 1,
wherein the fixing device is configured to fix a toner image to a recording material using heat generated by the heater via the fixing belt.
